(19) United States
(12) Patent Application Publication
(10) Pub. No.: US 2021/0222406 A1
(43) Pub. Date: Jul. 22, 2021

(54) METHODS AND SYSTEMS FOR GUIDING MISSION PLANNING IN A MACHINE SYSTEM

(71) Applicant: Caterpillar Inc., Peoria, IL (US)

(72) Inventors: Brian Gerard Funke, Peoria, IL (US); Paul D. Lenzen, Peoria, IL (US); Mo Wei, Dunlap, IL (US); Arvind Muthukumar, Peoria, IL (US)

(73) Assignee: Caterpillar Inc., Peoria, IL (US)

(21) Appl. No.: 16/749,009

(22) Filed: Jan. 22, 2020

(51) Int. Cl. E02F 9/26; E02F 9/20; G05D 1/00; H04W 4/029

(52) U.S. Cl. CPC E02F 9/262; E02F 9/205; G05D 2201/0202; E02F 9/2045; H04W 4/029; G05D 1/005

(57) ABSTRACT

A guide system for planning missions of autonomous or semi-autonomous material displacement machines includes an operator interface and at least one computer coupled with the operator interface. The at least one computer is structured to receive working elevation information associated with missions executed by machines and indicative of working elevation parameters dependent upon disposition of a material displaced by the machines. The guide system is further structured to receive surrounding terrain information and compare the working elevation parameters to a surrounding elevation parameter. The guide system produces elevation variance alerts based on the comparison, and displays the elevation variance alerts in an operator-perceptible form such as graphically on a display in an operator interface.

### TECHNICAL FIELD

The present disclosure relates generally to mission planning in an autonomous or semi-autonomous machine system, and more particularly to producing an elevation variance alert based on a difference between a working elevation parameter and a surrounding elevation parameter.

### BACKGROUND

Machines such as tractors, graders, scrapers, wheel loaders, and various others are used throughout the world to displace material in a work area, by removal, delivery, or redistribution operations. For example, the operations may include removal of overburden at mine sites, production of ore, and surface contouring for construction, dam or road building, and various others. In recent years, there has been increased interest in automating at least some of the functionality of such machines and processes, enabling a single operator to monitor and direct the activities of several different machines, either on-site or from a remote management office.

One example of a machine system that has seen practical application in relation to semi-autonomous operation is known from the surface mining field, where a plurality of dozing tractors are operated using a combination of remote operator control and machine autonomy. The dozing tractors remove overburden from “slots” in preparation of a work area for removal of a target material such as an ore or coal with a rope shovel, drag line, or other equipment. In a typical semi-autonomous slot dozing application, an operator remotely monitors the progress of dozing tractors, each tractor pushing material from a slot according to assigned tasks. When an operator or the monitoring equipment determines that sufficient progress has been made, or progress has stalled, the operator can assign a dozing tractor to start or continue with displacement of material in a new slot. While known applications in this and related fields have increasingly seen commercial success, there is always room for improved efficiency. One known strategy for improved efficiency in an autonomous or semi-autonomous system of machine operation is known from U.S. Pat. No. 8,948,981 to Wei et al.

### SUMMARY OF THE INVENTION

In one aspect, a method of guiding mission planning in a machine system includes tracking a location of a machine structured to execute a mission according to coordinates in a work area, and monitoring a working elevation parameter that is dependent on disposition of a material displaced by the machine during execution of the mission. The method further includes comparing the working elevation parameter to a surrounding elevation parameter, and producing an elevation variance alert associated with the mission based on the comparison of the working elevation parameter to the surrounding elevation parameter.

In another aspect, a machine system includes a machine structured to displace a material in a work area, and a guide system including at least one computer. The at least one computer is structured to receive location information of the machine during execution of a mission according to coordinates in the work area, and receive working elevation information indicative of a working elevation parameter that is dependent upon disposition of a material displaced by the machine during execution of the mission. The at least one computer is further structured to receive surrounding terrain information indicative of a surrounding elevation parameter, compare the working elevation parameter to the surrounding elevation parameter, and produce an elevation variance alert associated with the mission, based on the comparison of the working elevation parameter to the surrounding elevation parameter.

In still another aspect, a guide system for planning missions of autonomous or semi-autonomous material displacement machines includes an off-board operator interface structured to receive operator inputs for assignment or reassignment of missions for the material displacement machines in a work area. The guide system further includes at least one computer coupled with the off-board operator interface and structured to receive location information of the material displacement machines during execution of missions in the work area, and to receive working elevation information indictive of working elevation parameters associated with the missions and each dependent upon disposition of a material displaced by the machines during execution of the respective missions. The at least one computer is further structured to receive surrounding terrain information indicative of surrounding elevation parameters associated with the respective missions, and compare the working elevation parameters to the respective surrounding elevation parameters. The at least one computer is still further structured to produce elevation variance alerts associated with the missions, based on the comparison of the working elevation parameters to the respective surrounding elevation parameters, and cause the off-board operator interface to produce the elevation variance alerts in an operator-perceptible form.

### BRIEF DESCRIPTION OF THE DRAWINGS

FIG. 1 is a diagrammatic view of a machine system, according to one embodiment;

FIG. 2 is a diagrammatic view of machines in a machine system as in FIG. 1, executing missions within a work area;

FIG. 3 is a diagrammatic view of a display, according to one embodiment;

FIG. 4 is a diagrammatic view of a graphic for displaying on a display, according to one embodiment; and

FIG. 5 is a flowchart illustrating example methodology and control logic flow, according to one embodiment.

### DETAILED DESCRIPTION

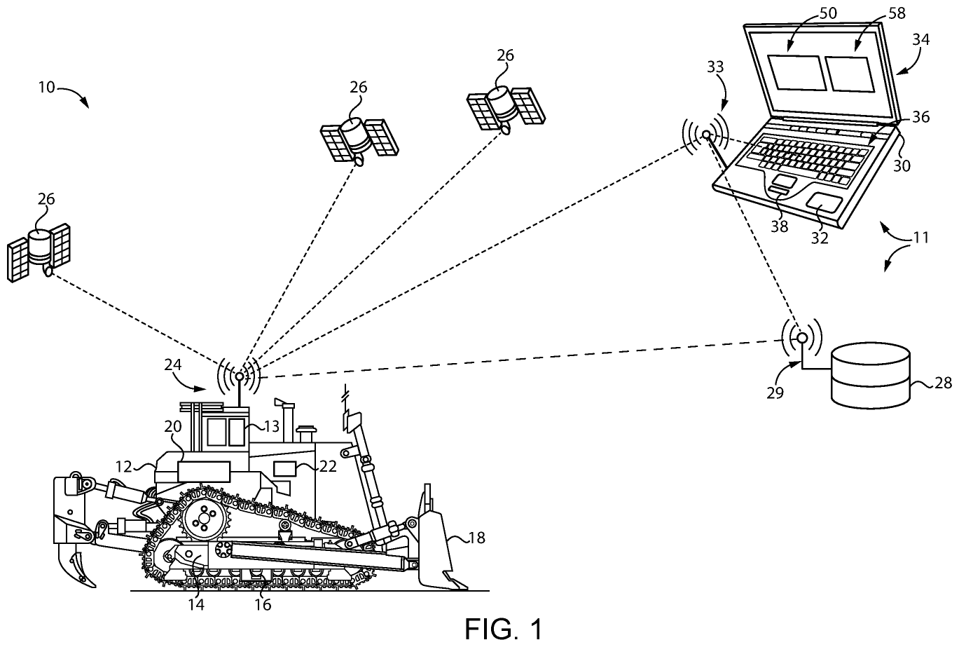

Referring to FIG. 1, there is shown a machine system 10 according to one embodiment, and including a machine 12 structured to displace a material in a work area. Machine 12 is shown in the context of a track-type tractor having a frame 14, ground-engaging elements 16, and an implement 18. Ground-engaging elements 16 can include tracks positioned upon each side of frame 14, however, a wheeled machine, or a half-track machine, for example, might be used in some applications. Multiple machines of the same or different types could be used in machine system 10, displacing material by way of different and/or the same techniques amongst the machines.

Implement 18 includes a blade, such as a dozing blade, mounted at a front end of frame 14. In other embodiments, an implement could be mounted at another location, such as a back end of a machine frame, between front and back ends, or in still another arrangement. Instead of a blade, embodiments are contemplated where a machine according to the present disclosure is equipped with a bucket. In still other instances, for example a scraper application, an implement could include apparatus for cutting and loading material from a substrate and storing on-board the substrate material in a hopper or the like. In a practical implementation strategy, machine 12 includes a generally known type of dozing machine or tractor, having a rearwardly mounted ripper (not numbered).

Machine 12 may also include on-board steering, propulsion, and implement systems including, for instance, hydraulically actuated cylinders, pumps, hydraulic motors, and/or suitable mechanical gearing and driveshafts for operating ground-engaging elements 16 in forward directions, reverse directions, and differentially to move machine 12 forward, back, through turns, et cetera, in a work area. Machine 12 may further include on-board power equipment, including an internal combustion engine, an engine-generator set, or still another, and an on-board navigation system 13 to receive global or local positioning information and appropriately control steering, power, and other functions according to predefined parameters. A steering system, a propulsion system, and an implement system are referenced collectively as on-board mechanical systems and indicated at reference numeral 20. At least some of on-board mechanical systems 20 may be autonomously or semi-autonomously operated.

Machine 12 further includes an on-board control system, including an electronic control unit 22, structured for monitoring and operating on-board mechanical systems 20, navigation system 13, and for external communication. The external communications includes but is not limited to communication with other machines, operator control stations, and data or control command sources as further discussed herein. Machine 12 also includes a transmitter-receiver 24 in communication with electronic control unit 22 and navigation system 13, and structured to transmit and receive wireless signals for communicating with other equipment and monitoring various environmental and operating conditions. Transmitter-receiver 24 may be in communication with global positioning system (GPS) satellites 26, or a ground-based local positioning system (not shown).

Machine system 10 also includes an operator control computer 30 having an electronic control unit 32, a transmitter-receiver 33, a display 34, and an operator interface 36 having at least one operator input device 38 such as a mouse, keyboard, touchscreen, joystick, or still another. Display 34 could include a touchscreen display or could be a passive display such as a conventional computer display. Operator control computer 30 may further be in communication with machine 12, and also with one or more servers 28. Server(s) 28 can include a terrain server dedicated to storage and management of terrain information, or still another server computer, such as a server running mine management software. Server(s) 28 could thus be a single server, or a plurality of servers, which may either be housed together or housed separately.

Server(s) 28, electronic control unit 32 of machine 12, electronic control unit 22 of operator control computer 30, as well as other computers in machine system 10, collectively formulate a guide system 11. Alternatively guide system 11 may include additional wired or wireless components. It should be appreciated that a guide system as contemplated herein can include at least one computer, potentially several computers, structured to perform data processing, condition monitoring, machine assignment, dispatch, and mission planning guidance functions of machine system 10 as further discussed herein. Each of the computers in guide system 11 can include one or more data processors, such as microprocessors or microcontrollers, for example, or any other suitable central processing unit, and a computer readable memory, such as RAM, ROM, EEPROM, DRAM, SDRAM, Flash, etc., storing computer executable program instructions and data structures. Those skilled in the art will appreciate that the computerized functionality of machine system 10 could be divided, subdivided, or combined amongst different computers in a great many different ways, and thus discussion herein of the structure or functioning of any one computer or electronic control unit can be understood to refer by way of analogy to one or more computers in any of the numerous suitable arrangements.

In the illustrated embodiment, operator control computer 30 may be located remote from machine 12 and remote from server 28. It is thus contemplated that, in relation to the location of machine 12, operator control computer 30 may be an off-board computer, and operator interface 36 is an off-board operator interface. In some embodiments, operator control computer 30 could be located on-board machine 12, or located on-board one machine of several machines in machine system 10. It is also contemplated that machine 12, and other similar machines of machine system 10, can be operated fully autonomously apart from assignment and/or reassignment to specified missions, or semi-autonomously where one or more of machine navigation, implements, and/or other parameters are controlled in whole or in part directly by a remote operator. Still other combinations of autonomous and non-autonomous control will fall within the scope of the present disclosure.

In one practical implementation, machine 12 is assigned and dispatched to a specified mission for displacing material in a work area, such as a slot dozing mission. When the slot dozing mission is completed, or reassignment to another mission is otherwise justified, an operator can assign and dispatch machine 12 by way of commands entered at operator interface 36 of operator control computer 30 to a new mission assignment or a reassignment. Operator control computer 30, and operator interface 36, can include at least one operator input device 38, as noted above, enabling an operator to input control commands for various aspects of operation of machine system 10. Indicated upon display 34 is a first graphical display 50, and a second graphical display 58 which can include a graphical user interface as further discussed herein.

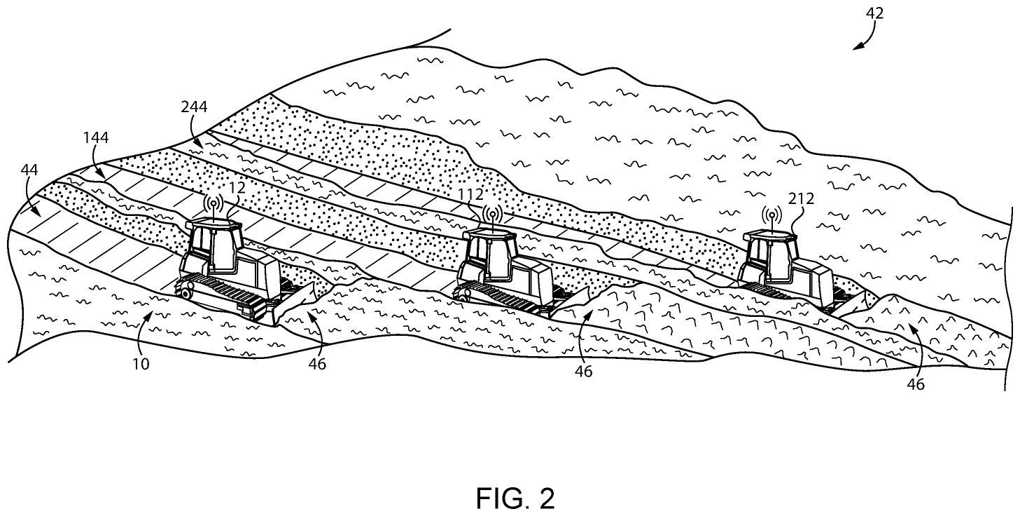

Referring also to FIG. 2, there are shown several machines of similar type including machine 12, a similar or identical machine 112, and another similar or identical machine 212. Machines 12, 112, and 212 are shown as they might appear displacing material from separate regions of a work area 42, namely, a first, a second, and a third slot indicated by reference numerals 44, 144, and 244. In one application, for example, each of machines 12, 112, and 212 are assigned a separate slot in work area 42 and operated to displace material from a source location within the slot 44, 144, or 244, to a destination area at specified coordinates, and ultimately produce a specified base elevation.

In other words, machines 12, 112, and 212 will be understood to displace a material 46, such as overburden, from slots 44, 144, and 244, until the height of the slots have been reduced in elevation a specified amount from a starting elevation, or to a specified absolute elevation. With material 46 displaced from slots 44, 144, 244, a rope shovel, drag line, or other equipment can be used to remove underlying target material of an ore body, for example. In other example applications, machines 12, 112, 212 could deliver, redistribute, or perform any combination of displacement, delivery, or redistribution of a material within regions of a work area corresponding to assigned missions.

Those skilled in the art will appreciate that machines 12, 112, and 212, can move in forward and reverse directions within the respective slots numerous times to complete the assigned mission. In one example, a mission includes the details required for a machine to carry out a series of tasks, until completing the work defined by the mission. It has been observed that the time required for completion of missions can vary from slot-to-slot, due to the presence of varying types of substrate materials. Additionally, mission completion time may vary as a function of, varying conditions such as moisture level, the presence of foreign objects in the slots such as large rocks, and the like. When one machine has completed a mission, such as by reducing a base elevation of the associated slot a prescribed amount, the machine can be assigned a new mission for displacing material from another slot.

It has also been observed that in certain circumstances it may be necessary to idle a machine while other machines complete their missions, or progress further in the execution thereof. One condition where machines may be idled, or used at less than optimal efficiency, is where a difference in elevation between an area a machine is assigned to work and surrounding terrain exceeds a certain threshold. In other words, operators may need to stop or slow progress of one or more machines in a machine system because an elevation difference between a working location of one machine and surrounding terrain has become greater than desired. The surrounding terrain could be another area being actively worked by another machine, or the surrounding terrain could be an area outside of areas being actively worked.

The present disclosure contemplates guiding mission planning in machine system 10 using one or more computers of guide system 11. Guiding mission planning includes tracking a location of a machine, for example, each of machines 12, 112, 212, structured to execute a mission within the subregion in a work area identified by a set of coordinates. As discussed herein, a mission can include dozing a slot to a specified absolute or relative base elevation depth, the slot having a starting location coordinate, and an ending location coordinate on the longitudinal axis, a starting location coordinate, and an ending location coordinate on the vertical axis, path coordinates between a starting location and an ending location, and potentially spatial area or lateral boundary coordinates, in a 2-dimensional or geospatial reference frame. The subject coordinates could be GPS or local positioning system coordinates. In other embodiments, a mission could be defined in other ways, for example in a 3-dimensional geospatial reference frame.

Guiding mission planning in machine system 10 using one or more computers of guide system 11 can further include monitoring a working elevation parameter that is dependent upon disposition of a material displaced by a machine during execution of the assigned mission. Monitoring the working elevation parameter can include monitoring a working elevation parameter indicative of a base elevation of an assigned slot. It will be recalled that a mission according to the present disclosure can include displacement of a substrate material from a work area. In other instances, a mission according to the present disclosure could include delivery of a material to a region of a work area defined by specified coordinates, or redistribution of a material within a work area.

Guiding mission planning in machine system 10 can further include comparing the working elevation parameter to a surrounding elevation parameter. As discussed above, information as to surrounding elevation can serve to trigger an action in furtherance of guiding mission planning. The surrounding elevation parameter can include a second working elevation parameter that is indicative of a base elevation of a second slot, for example. Information indicative of the working and surrounding elevation parameters can be produced by on-board equipment of machines 12, 112, 212, or by off-board scanning equipment.

Guiding mission planning in machine system 10 can still further include producing an elevation variance alert associated with a mission based on the comparison of the working elevation parameter to the surrounding elevation parameter. In one implementation, comparing of a working elevation parameter to a surrounding elevation parameter can include calculating an elevation difference. Calculation of the elevation difference might include calculating an actual difference between two working elevations, or calculating an elevation difference relative to an external reference. The elevation difference could be a quantitative term, for example “X” meters, or a qualitative term in some instances such as “high,” “medium high”, “very high,” “low”, “medium low,” and so on. Guiding mission planning in machine system 10 can still further include determining the calculated elevation difference exceeds a threshold elevation difference, for example, a threshold elevation difference specified by an operator during mission planning as further discussed herein.

Producing an elevation variance alert associated with a mission as contemplated herein can include producing an operator-perceptible elevation variance alert which can notify an operator, that a working elevation parameter, in comparison to a surrounding elevation parameter, either exceeds a threshold, or is anticipated to exceed a threshold upon completion of the presently assigned mission. Further, the elevation variance alert may prompt the operator to initiate an action related to mission planning. In other words, an operator-perceptible alert can be generated, or caused to be generated, by one of the computers of guide system 11 that notifies an operator to consider reassignment of one or more machines based on the elevation difference, or consider taking some other corrective action.

An operator-perceptible alert can be produced on operator interface 36, for example, and could include an audible alert, a haptic alert, or a visual alert in the nature of display of a graphical alert such as on display 34, or some combination of these. Displaying a graphical alert can include displaying a first graphical alert, if the elevation difference has a positive value, and displaying a second graphical alert, different from the first graphical alert, if the elevation difference has a negative value. In other words, with respect to a given mission, and in the illustrated case a given slot, if an elevation difference between a base elevation of the given slot and an elevation of surrounding terrain, such as a base elevation of another slot, is a positive difference the operator can be notified in a first way, and if the difference is negative, the operator can be notified in a second way. An extreme positive difference might indicate a mound in a given slot, a mound in a given slot and a ditch in an adjacent slot, or some other irregularity, whereas an extreme negative difference might indicate inverse patterns of a mound and ditch, for instance. Analogous functionality of differing alert types could be used in other sensory modalities such as audible or haptic.

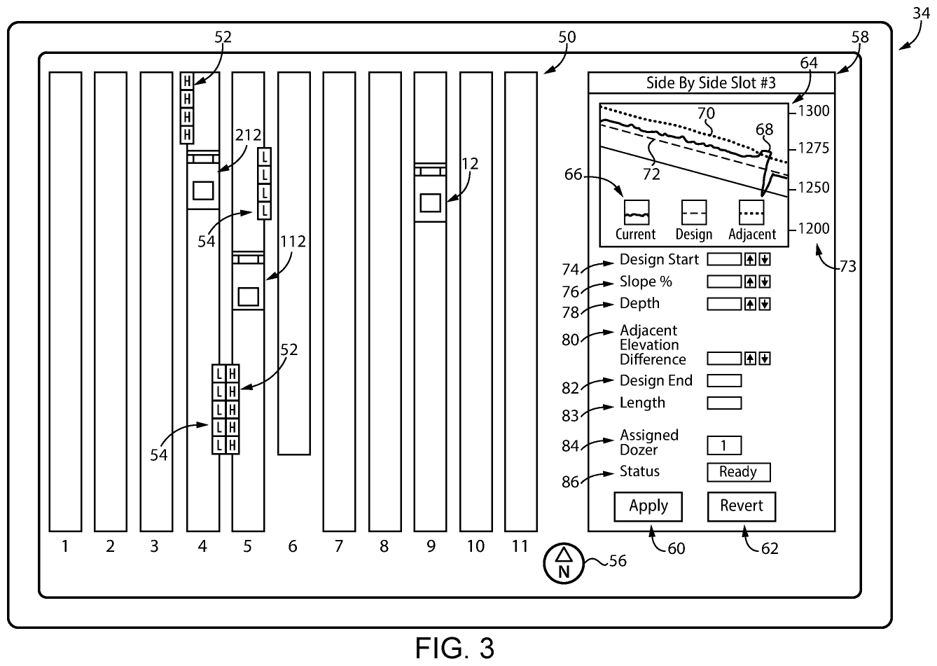

Referring now also to FIG. 3, there is shown display 34 as it might appear displaying a first graphical display 50, for monitoring operation and progress of a plurality of machines 12,112,212 executing a plurality of missions, and an interactive graphical user interface (GUI) 58 for use in mission planning. Display 50 and graphical user interface 58 might or might not be displayed simultaneously to an operator. In FIG. 3 eleven slots 1-11 are shown in graphical display 50, as work area 42 might appear represented in a bird's eye view. Locations of each of machines 12,112, 212, are being tracked and displayed to an operator approximately as they would appear in real time. It can be noted that machine 12 is displacing material in a slot 9, machine 112 is displacing material in a slot 5 and machine 212 is displacing material in a slot 4. It can also be seen that icons are displayed along some of the slots, including elevation difference indicators 52 along a left side of slot 4, elevation indicators 52 along a left side of slot 5, elevation indicators 54 along a right side of slot 5, and elevation indicators 54 along a right side of slot 4. Elevation difference indicators are examples of elevation difference alerts produced in an operator-perceptible form.

In the illustrated embodiment, the respective elevation indicators displayed can correspond to an approximate location along the respective slots where an elevation difference exceeding a threshold difference has been determined. For instance, a base elevation of slot 5 along indicators 54 is less than a base elevation of slot 6 along the indicated length by an amount exceeding an elevation threshold, such as 1 meter, 1.5 meters, 2 meters, or another amount. Elevation indicators 52 include boxes with the letter H within indicating that a positive (high) elevation difference is observed between the subject slot and an adjacent slot, whereas elevation indicators 54 include boxes with the letter L within indicating that a negative (low) elevation difference is observed between the subject slot and an adjacent slot. Indicators 52 might be a first color, such as blue, and indicators 54 a second color, such as red. Thus, an operator can conclude that along a portion of slot 4 ahead of machine 212, a base elevation of slot 4 exceeds a base elevation of slot 3 by a threshold elevation difference. Analogously, an operator can conclude that along a portion of slot 5 ahead of machine 112 a base elevation of slot 5 is less than a base elevation of slot 6 by a threshold difference. Behind machines 112 and 212 in slots 5 and 6 an operator can conclude that slot 5 is higher than slot 4 by the threshold difference, and that slot 4 is lower than slot 5 by a threshold difference.

In view of FIG. 3 it will be appreciated that an elevation variance alert associated with a first mission, for example the mission being executed by machine 122, is produced, while an inverse elevation variance alert associated with a second mission, the mission being executed by machine 212, can be simultaneously produced and displayed to an operator. It will also be recalled that graphical alerts can include a first graphical alert if an elevation difference has a positive value, such as the elevation difference between slot 5 and slot 4, and a second graphical alert can be displayed if the elevation difference has a negative value, such as the elevation difference between slot 4 and slot 5, in the areas associated on graphical slot display 50 with the respective slots.

Interactive graphical user interface 58 might be displayed in conjunction with the operator also viewing graphical display 50. Alternatively, interface 58 may be displayed independent of display 50. Graphical user interface 58 can include an elevation profile graphic 64 that shows, in a side view, what an operator might view when planning a mission assignment such as for slot 3. Elevation profile graphic 64 can include a key 66 designating different line type or colors for a current profile 68, an adjacent profile 70, and a present design profile 72. A target profile for the slot at completion of the present mission could also be displayed. In other words, an operator can view on graphical user interface 58 an actual present profile of a slot 68, an actual profile of an adjacent slot 70, and a configurable design profile 72. An actual elevation range is shown at 73.

Graphical user interface 58 can also include different configurable parameters that an operator can adjust, including a design start location 74 or coordinate(s), a slope percent 76, a slot depth 78, an adjacent elevation difference 80, a design end location 82 or coordinate(s), a slot length 83, an assigned dozer 84, and a status 86 (Ready or Not Ready, for example). Also shown on graphical user interface 64 is an Apply box or button 60 and a Revert box or button 62, to apply mission parameters as configured or revert to a default, for example. An operator can thus enter desired values or coordinates for parameters 74, 76, 78, and potentially parameters 82, 83, and 84, and still others not pictured. In one embodiment, an operator could specify the adjacent elevation difference 80 that corresponds to the elevation threshold difference. Thus, on graphical slot display 50 elevation difference indicators 52 and 54 will be displayed based on comparison of a working elevation parameter to a surrounding elevation parameter according to an elevation difference input by an operator.

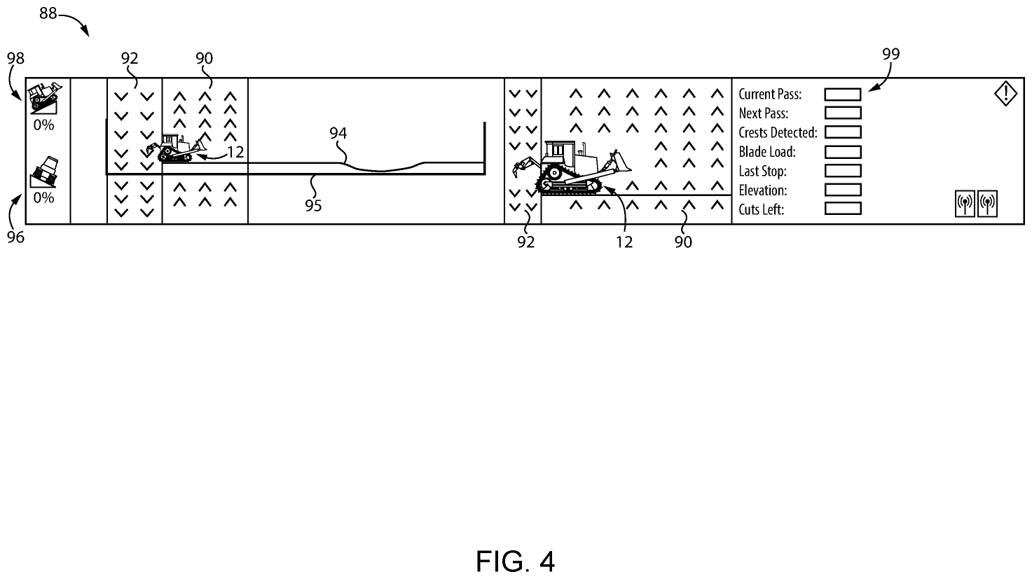

Referring now to FIG. 4, there is shown a different graphical slot display 88 that can be displayed to an operator on display 34. It is contemplated that operator control computer 30 can be configured to display a view of a given slot in comparison to a slot adjacent on a first side, or a slot adjacent on a second side, for example, thus enabling the operator to look at different mission progress or other status conditions for use in mission planning. In FIG. 4, machine 12 is shown as it might appear along a profile 94 of a slot presently being worked. Graphical slot display 88 shows two similar views, a first view displayed in the left half of the image versus a second, zoomed-in, view displayed in the right half of the image, which can be enlarged, selected to display only one, or otherwise configured to provide multiple simultaneous views.

As shown in FIG. 4, machine 12 is along a profile 94 representing a present slot base elevation profile, within a zone that is presently a high or low zone 90, exceeding an elevation difference threshold relative to an adjacent slot. A target profile is shown at 95. A first color might be used where zone 90 is high relative to an adjacent slot base elevation, and a second color used where zone 90 is low relative to an adjacent slot base elevation. Instead of different colors, shading, hatching, or another indicator could be used to indicate variation in slot elevation. Zone 90 could also be displayed differently from other zones regardless of whether it is low or high. In other words, both a high condition or a low condition could cause zone 90 to be displayed the same way, but different from other zones. The graphical display of zone 90 is another example of an elevation variance alert as contemplated herein. Adjacent to zone 90, a zone 92 is displayed, such as by color, hatching, etc., to stand apart from zone 90 and other zones, to indicate that zone 92 is not associated with reliable elevation data. Another way to interpret FIG. 4 is that machine 12 is presently in a part of its slot (zone 90) that is higher or lower than an adjacent slot, and has passed a region (zone 92) for which data is unreliable or unavailable. Various machine parameters are indicated for a given machine on graphical slot display 88, including a pitch indicator shown at 98 and a roll indicator shown at 96. Various additional parameter indicators for a given machine, slot, or mission are shown at 99.

### INDUSTRIAL APPLICABILITY

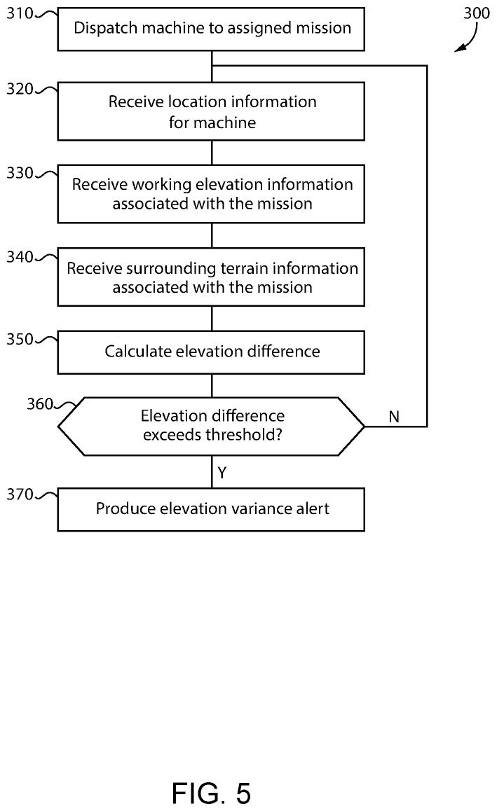

Referring to the drawings generally, but also now to FIG. 5 there is shown a process 300 illustrating example methodology and logic flow, executed by a machine system 10 and guide system 11, according to the present disclosure. At a block 310 a machine is dispatched to an assigned mission. From block 310 process 300 advances to a block 320 to receive location information for the assigned machine. From block 320 process 300 advances to a block 330 to receive working elevation information associated with the mission, and thenceforth to a block 340 to receive surrounding terrain information associated with the mission. From block 340 process 300 advances to a block 350 to calculate an elevation difference as discussed herein. At a block 360 it is queried whether the elevation difference exceeds a threshold. If the elevation threshold is not exceeded at block 360, process 300 can return to execute previous steps again, or could exit. Alternatively, if the elevation threshold is exceeded at block 360, process 300 can advance to a block 370 to produce an elevation variance alert as discussed herein.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed:

1. A method of guiding mission planning in a machine system comprising:
tracking a location of a machine structured to execute a mission according to coordinates in a work area;
monitoring a working elevation parameter that is dependent upon disposition of a material displaced by the machine during execution of the mission;
comparing the working elevation parameter to a surrounding elevation parameter; and
producing an elevation variance alert associated with the mission based on the comparison of the working elevation parameter to the surrounding elevation parameter.

2. The method of claim 1 wherein the tracking of a location of a machine includes tracking a location of a machine structured to displace a substrate material from a region of the work area that is defined by the coordinates.

3. The method of claim 2 wherein the machine includes a dozing machine and the region of the work area includes a slot defined by the coordinates, and the monitoring of the working elevation parameter includes monitoring a working elevation parameter indicative of a base elevation of the slot.

4. The method of claim 3 further comprising monitoring a second working elevation parameter that includes the surrounding elevation parameter and is indicative of a base elevation of a second slot.

5. The method of claim 4 further comprising producing an inverse elevation variance alert associated with a second mission based on a difference between the second working elevation parameter and the first working elevation parameter.

6. The method of claim 1 wherein the producing of an elevation variance alert includes producing an operator perceptible alert on an off-board operator interface for controlling the machine.

7. The method of claim 6 wherein the comparing of the working elevation parameter to a surrounding elevation parameter further includes calculating an elevation difference, and further comprising determining the elevation difference exceeds a threshold elevation difference.

8. The method of claim 7 wherein the producing of an elevation variance alert further includes displaying a graphical alert on a display of the off-board operator interface.

9. The method of claim 8 wherein the displaying of a graphical alert further includes displaying a first graphical alert, if the elevation difference has a positive value, and displaying a second graphical alert, different from the first graphical alert, if the elevation difference has a negative value.

10. A machine system comprising:
a machine structured to displace a material in a work area;
a guide system including at least one computer structured to:
receive location information of the machine during execution of a mission according to coordinates in the work area;
receive working elevation information indicative of a working elevation parameter that is dependent upon disposition of a material displaced by the machine during execution of the mission;
receive surrounding terrain information indicative of a surrounding elevation parameter;
compare the working elevation parameter to the surrounding elevation parameter; and
produce an elevation variance alert associated with the mission, based on the comparison of the working elevation parameter to the surrounding elevation parameter.

11. The machine system of claim 10 further comprising an operator interface having a display structured to display the elevation variance alert.

12. The machine system of claim 11 wherein:
the machine includes an on-board navigation system for autonomous navigation according to the coordinates; and
the operator interface includes an off-board operator interface, and the at least one computer is further structured to cause the off-board operator interface to produce the elevation variance alert in an operator-perceptible form.

13. The machine system of claim 12 wherein:
the machine includes a dozing machine and the working elevation parameter is indicative of a base elevation of a slot defined by the coordinates; and
the machine system further includes a second dozing machine.

14. The machine system of claim 13 wherein the at least one computer is further structured to monitor a second working elevation parameter that includes the surrounding elevation parameter and is indicative of a base elevation of a second slot defined by second coordinates.

15. The machine system of claim 14 wherein the at least one computer is further structured to produce, simultaneous with the elevation variance alert, an inverse elevation variance alert associated with a second mission executed by the second dozing machine.

16. The machine system of claim 11 wherein the at least one computer is further structured to:
compare the working elevation parameter to the surrounding elevation parameter by calculating an elevation difference; and
produce the elevation variance alert where the elevation difference exceeds a threshold elevation difference.

17. The machine system of claim 16 wherein the at least one computer is further structured to cause the operator interface to:
display a first graphical alert, if the elevation difference has a positive value; and
display a second graphical alert, different from the first graphical alert, if the elevation difference has a negative value.

18. A guide system for planning missions of autonomous or semi-autonomous material displacement machines, the guide system comprising:
an off-board operator interface structured to receive operator inputs for assignment or reassignment of missions for the material displacement machines in a work area;
at least one computer coupled with the off-board operator interface and structured to:
receive location information of the material displacement machines during execution of missions in the work area;
receive working elevation information indicative of working elevation parameters associated with the missions and each dependent upon disposition of a material displaced by the machines during execution of the respective missions;
receive surrounding terrain information indicative of surrounding elevation parameters associated with the respective missions;
compare the working elevation parameters to the respective surrounding elevation parameters;
produce elevation variance alerts associated with the missions, based on the comparison of the working elevation parameters to the respective surrounding elevation parameters; and
cause the off-board operator interface to produce the elevation variance alerts in an operator-perceptible form.

19. The guide system of claim 18 wherein the at least one computer is further structured to:
compare the working elevation parameters to the respective surrounding elevation parameters by calculating elevation differences;
produce the elevation variance alerts where the elevation differences exceed a threshold elevation difference;
wherein the elevation alerts include a first graphical alert, if the respective elevation difference has a positive value, and a second graphical alert, different from the first graphical alert, if the respective elevation difference has a negative value.

20. The guide system of claim 19 wherein the first graphical alert has a first display color and the second graphical alert has a second display color.
